(19) United States
(12) Patent Application Publication
(10) Pub. No.: US 2023/0048175 A1
(43) Pub. Date: Feb. 16, 2023

(54) RAPIDLY SINTERED CATHODES WITH HIGH ELECTRONIC CONDUCTIVITY

(71) Applicant: Corning Incorporated, Corning, NY (US)

(72) Inventors: Cameron Wayne Tanner, Horseheads, NY (US); Elizabeth Marie Vileno, Corning, NY (US); Lingyan Wang, Horseheads, NY (US)

(21) Appl. No.: 17/389,463

(22) Filed: Jul. 30, 2021

(51) Int. Cl. H01M 4/04; H01M 4/525; H01M 4/505; H01M 4/58; H01M 10/0525; H01M 10/0562

(52) U.S. Cl. CPC H01M 4/0471; H01M 4/525; H01M 4/505; H01M 4/5815; H01M 4/0407; H01M 4/0404; H01M 10/0525; H01M 10/0562; H01M 2004/021

(57) ABSTRACT

A method for forming a treated sintered composition includes: providing a slurry precursor including a lithium-, sodium-, or magnesium-based compound; tape casting the slurry precursor to form a green tape; sintering the green tape at a temperature in a range of 500° C. to 1350° C. for a time in a range of less than 60 min to form a sintered composition; and heat treating the sintered composition at a temperature in a range of 700° C. to 1100° C. for a time in a range of 1 min to 2 hrs in an oxygen-containing atmosphere to form the treated sintered composition.

### BACKGROUND

### 1. Field

This disclosure relates to rapidly sintered cathodes with high electronic conductivity.

### 2. Technical

Efforts to increase energy density of lithium ion (Li-ion) batteries are being pursued using a variety of approaches. One way is to suppress the amount of inactive material by thinning the solid electrolyte and increasing loadings of active materials in electrodes. Another is development of solid electrolytes that enable lithium metal anodes.

Battery architectures based upon rapidly sintered cathodes can be used to increase energy density in both ways. The present application discloses continuous and rapidly sintered cathodes with improved properties, such as electronic conductivity.

### SUMMARY

In some embodiments, a method for forming a treated sintered composition, comprises: providing a slurry precursor including a lithium-, sodium-, or magnesium-based compound; tape casting the slurry precursor to form a green tape; sintering the green tape at a temperature in a range of 500° C. to 1350° C. for a time in a range of less than 60 min to form a sintered composition; and heat treating the sintered composition at a temperature in a range of 700° C. to 1100° C. for a time in a range of 1 min to 2 hrs in an oxygen-containing atmosphere to form the treated sintered composition.

In one aspect, which is combinable with any of the other aspects or embodiments, the heat treating is conducted at a temperature in a range of 750° C. to 900° C. for a time in a range of 10 min to 1 hr. In one aspect, which is combinable with any of the other aspects or embodiments, the oxygen-containing atmosphere comprises >0% to 70 vol. % O₂. In one aspect, which is combinable with any of the other aspects or embodiments, the oxygen-containing atmosphere is air. In one aspect, which is combinable with any of the other aspects or embodiments, the oxygen-containing atmosphere comprises at least one non-reactive gas. In one aspect, which is combinable with any of the other aspects or embodiments, the oxygen-containing atmosphere does not include another reactive gas.

In one aspect, which is combinable with any of the other aspects or embodiments, the heat treating is conducted by: inserting the sintered composition into a furnace at a first rate; holding the sintered composition for a predetermined time; withdrawing the sintered composition from the furnace at a second rate. In one aspect, which is combinable with any of the other aspects or embodiments, the first rate is approximately equal to the second rate. In one aspect, which is combinable with any of the other aspects or embodiments, the predetermined time is in a range of 1 min to 30 min.

In one aspect, which is combinable with any of the other aspects or embodiments, the lithium-based compound comprises at least one of lithium cobaltite (LCO), lithium manganite spinel (LMO), lithium nickel cobalt aluminate (NCA), lithium nickel manganese cobalt oxide (NMC), lithium iron phosphate (LFP), lithium cobalt phosphate (LCP), lithium titanate, lithium niobium tungstate, lithium titanium sulfide, or combinations thereof. In one aspect, which is combinable with any of the other aspects or embodiments, the lithium-, sodium-, or magnesium-based compound is at least 50 wt. % of the total slurry precursor. In one aspect, which is combinable with any of the other aspects or embodiments, the magnesium-based compound comprises: at least one of NaVPO₄F, NaMnO₂, Na_{2/3}Mn_{1-y}Mg_{y}O₂ (0<y<1), Na₂Li₂Ti₅O₁₂, Na₂Ti₃O₇, MgCr₂O₄, or MgMn₂O₄.

In one aspect, which is combinable with any of the other aspects or embodiments, the slurry precursor further comprises at least one, solvent, dispersant, and plasticizer. In one aspect, which is combinable with any of the other aspects or embodiments, the tape casting comprises: forming the slurry precursor to a sheet configuration having a thickness in a range of 5 μm to 100 μm; and drying the sheet configuration such that a combination of the at least one solvent, dispersant, and plasticizer does not exceed 10 wt. % of the dried sheet. In one aspect, which is combinable with any of the other aspects or embodiments, the method further comprises: debinding the dried sheet at a predetermined temperature. In one aspect, which is combinable with any of the other aspects or embodiments, the predetermined temperature is in a range of 175° C. to 350° C. In one aspect, which is combinable with any of the other aspects or embodiments, the step of debinding and the step of sintering is conducted simultaneously. In one aspect, which is combinable with any of the other aspects or embodiments, the method further comprises: pyrolyzing organics in the dried sheet at a temperature in a range of 175° C. to 350° C.

In one aspect, which is combinable with any of the other aspects or embodiments, the sintering is conducted for a time in a range of less than 45 min. In one aspect, which is combinable with any of the other aspects or embodiments, the sintering comprises: continually feeding the green tape through a sintering chamber at a predetermined rate measured in in/min. In one aspect, which is combinable with any of the other aspects or embodiments, a final thickness of the sintered composition is in a range of 2 μm to 100 μm immediately after the sintering without further processing.

In some embodiments, a treated sintered composition, comprises: at least one of lithium cobaltite (LCO), lithium manganite spinel (LMO), lithium nickel cobalt aluminate (NCA), lithium nickel manganese cobalt oxide (NMC), lithium iron phosphate (LFP), lithium cobalt phosphate (LCP), lithium titanate, lithium niobium tungstate, lithium titanium sulfide, or combinations thereof, wherein the treated sintered composition has an electronic conductivity of at least 10⁻⁵ S/cm.

In one aspect, which is combinable with any of the other aspects or embodiments, the treated sintered composition has an electronic conductivity of at least 10⁻⁴ S/cm. In one aspect, which is combinable with any of the other aspects or embodiments, the treated sintered composition has a porosity of between 10% and 30%. In one aspect, which is combinable with any of the other aspects or embodiments, the treated sintered composition has a porosity of less than 10%. In one aspect, which is combinable with any of the other aspects or embodiments, the treated sintered composition has a porosity of less than 3%. In one aspect, which is combinable with any of the other aspects or embodiments, the treated sintered composition has at most trace quantities of a secondary conducting phase.

In some embodiments, an energy device, comprises: a first sintered, non-polished electrode having a first surface and a second surface; a first current collector disposed on the first surface of the first electrode; an electrolyte layer disposed on the second surface of the first electrode; and a second electrode disposed on the electrolyte layer.

In one aspect, which is combinable with any of the other aspects or embodiments, a second current collector is disposed on the second electrode. In one aspect, which is combinable with any of the other aspects or embodiments, the first electrode comprises the treated sintered composition as disclosed herein. In one aspect, which is combinable with any of the other aspects or embodiments, the electrolyte layer has a conductivity of at least 10'S/cm. In one aspect, which is combinable with any of the other aspects or embodiments, the first electrode is a substrate of the energy device.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 illustrates a lithium-ion battery described herein, according to some embodiments.

FIG. 2 illustrates a schematic cross-section of a conventional solid-state, thin-film micro-battery, according to some embodiments.

FIG. 3 illustrates particle size distribution of LCO powder after attrition milling in ceramic tape formation, according to some embodiments.

FIG. 4 illustrates temperature profile in rapid sintering apparatus starting from the entrance of the binder burn out zone, according to some embodiments.

FIG. 5 illustrates X-ray diffraction (XRD) traces of as-fired and ground cathodes rapidly sintered at 1050° C., according to some embodiments.

FIG. 6 illustrates a polished scanning electron microscopy (SEM) cross-section image of a representative cathode disk, according to some embodiments.

FIG. 7 illustrates electrical conductivity of LCO as-fired and as a function of heat treatment temperature for a fixed treatment time of 10 min and a fixed atmosphere of 20 vol. % 02 and 80 vol. % Ar, according to some embodiments.

FIG. 8 illustrates thermogravimetric analysis (TGA) analysis LCO powder in air, according to some embodiments.

FIG. 9 illustrates electrical conductivity of LCO as-fired and as a function of oxygen concentration for a fixed heat treatment temperature of 800° C. and time of 10 minutes and argon (Ar) as a make-up gas, according to some embodiments.

FIGS. 10-15 illustrate charge and discharge curves from the third cycle of coin cell C1a, C1b, C2a, C2b, C3, and C4, respectively, according to some embodiments.

FIG. 16 illustrates a polished cross-sectional scanning electron microscopy (SEM) image of a porous LCO cathode, according to some embodiments.

FIG. 17 illustrates charge and discharge curves from a coin cell comprising a porous LCO cathode, according to some embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

Recently, there has been increased activity in understanding how to increase energy density of batteries, for example, to reduce time intervals between charges, freeing space on the devices for other functionality, and in reducing weight where mobility is critical. In addition, higher energy density often leads to lower costs since fewer materials are consumed in manufacturing processes. The majority of attention has been focused on lithium-based batteries, and efforts can be broadly separated into two categories.

In one approach that is largely compatible with existing lithium battery manufacturing technology, advanced cathode materials with higher capacity like NMC 811 and NCA are being developed (either alone or in conjunction with surface coatings) or, increasing quantities of silicon may be added to the battery anode. In a second approach, technologies are aimed at enabling lithium metal anodes. This approach involves solid electrolytes such as lithium garnet, lithium phosophosilicate, and LiPON.

Currently, cathodes in lithium batteries used in personal devices (e.g., mobile phones, laptop computers, etc.) or electric vehicles (EVs) include about 90 wt. % of active material particles (e.g., LiCoO₂ (LCO)), about 5 wt. % of a binder (e.g., polyvinylidene fluoride (PVdF)), and about 5 wt. % carbon. The cathodes also have about 20% porosity for infiltration with a liquid electrolyte and have thickness in the range of 40-150 μm. However, the cathode, even with incorporated binder, is weak, friable, and not self-supporting.

The present disclosure relates generally to an electrode for a battery and to a method of preparing same. More specifically, novel, cathode-supported battery architectures are disclosed and may be designed for either existing lithium battery making processes or as a foundation for thin solid electrolytes (e.g., <10 μm) to enable lithium metal anodes.

Sintered cathodes enable higher energy density by more efficiently utilizing available space in two ways. First, the sintered electrode eliminates the need for (1) a binder to hold individual cathode particles together, and (2) carbon conductors to move electrical current to and from the particles. Both binders and carbon conductors are necessary components of current cathode materials (see above). Although five weight percent of each of the binder and carbon conductor appears small, this quantity translates to volume loadings of active material (after accounting for 20% porosity for infiltration with liquid electrolyte) of about 60%.

Second, the sintered cathode increases energy density by serving as a mechanical support. Typically, aluminum supports may be used as mechanical supports for the battery structure. A thickness of aluminum supports of only about 0.5 μm to 1.0 μm is sufficient for current distribution and collection. It is usually applied to one side of the cathode support by metal evaporation or other industrialized thin-film deposition process. The energy density of a sintered cathode like LCO or NMC as disclosed herein (i.e., without the need for aluminum supports), would increase by ˜50% by volume and about 27% by weight for porous structures, and ˜95% by volume and about 37% by weight for dense structures for solid-state batteries.

The present application discloses rapidly sintered cathodes with layered rock-salt structures (and methods of forming thereof) for use in cathode-supported batteries having electronic conductivities faster than lithium transport. Current solutions for cathodes in lithium ion batteries is to include carbon conductors to facilitate electron transport. The cathodes disclosed herein do not need a secondary conducting phase, and in fact, addition of secondary conductive phases to closed-pore sintered cathodes are not practical for manufacturing purposes.

Referring generally to the figures, various embodiments of a sintered electrode that includes at least one alkali metal or alkaline earth metal are disclosed. The sintered electrode has a thickness of 2 μm to 150 μm and a cross-sectional area of at least 3 cm². Compared to conventional electrode materials, the sintered electrode can be made much larger and self-supporting than typical thin-film formed electrodes and is usable without any additional finishing techniques, such as grinding or polishing, in contrast to other sintered electrodes. The disclosed sintered electrodes are able to achieve these advantages through a tape manufacturing process that allows for must faster manufacturing speeds of “medium” thickness electrode materials in which processing speed is independent of electrode thickness. That is, the electrodes can be made thicker than conventional electrodes made through thin film techniques and thinner than other sintered electrodes that have to be ground down to usable sizes. Moreover, the electrode can be rapidly sintered in a more economical process than is currently used for manufacturing electrode materials. Indeed, conventional processes typically utilize thin film techniques that are much slower and more difficult to build up thick layers. In this way, the relatively thicker sintered electrodes of the present disclose not only eliminate inactive components, such as mechanical supports, but also increase the charge capacity of the battery. Moreover, the thickness of the electrode and tape-casting manufacturing process allow for electrode materials to be manufactured in a roll-to-roll format.

The sintered electrodes disclosed herein are envisioned to be suitable for a variety of battery chemistries, including lithium-ion, sodium-ion, and magnesium-ion batteries as well those using solid state or liquid electrolyte. Various embodiments of the sintered electrode, manufacturing process, and lithium-ion batteries are disclosed herein. Such embodiments are provided by way of example and not by way of limitation.

As mentioned, various embodiments of a sintered electrode comprise at least one of an alkali metal or alkaline earth metal. In other embodiments, the sintered electrode may be a fluoride compound. In embodiments, the sintered electrode includes at least one of lithium, sodium, or magnesium. In embodiments, the sintered electrode also includes at least one transition metal, such as cobalt, manganese, nickel, niobium, tantalum, vanadium, titanium, copper, chromium, tungsten, molybdenum, tin, germanium, antimony, bismuth, or iron.

Exemplary embodiments of a lithium-based electrode include lithium cobaltite (LCO), lithium manganite spinel (LMO), lithium nickel cobalt aluminate (NCA), lithium nickel manganese cobalt oxide (NMC), lithium iron phosphate (LFP), lithium cobalt phosphate (LCP), lithium titanate, lithium niobium tungstate, lithium nickel manganate, and lithium titanium sulfide (LiTiS₂), among others. Exemplary embodiments of a sodium-based electrode include NaVPO₄F, NaMnO₂, Na_{2/3}Mn_{1-y}Mg_{y}O₂ (0<y<1), Na₂Li₂Ti₅O₁₂, or Na₂Ti₃O₇, among others. Exemplary embodiments of a magnesium-based include magnesiochromite (MgCr₂O₄) and MgMn₂O₄, among others.

In embodiments, the sintered electrode includes a first phase, and at least one other phase (e.g., a second phase, a third phase, a fourth phase, etc.) intermixed with the first phase. In embodiments, the additional phase or phases are selected to provide additional functionality. For example, in an embodiment involving a lithium electrode, a second phase enhances the effective lithium conductivity of the electrode, for example a lithium garnet phase. In an embodiment, the second phase enhances electronic conductivity. The additional phase or phases can be added prior to sintering, or the sintered electrode may contain open porosity that may be infiltrated with the additional phase or phases. In embodiments, the second phase is a spinel that provides additional electronic conductivity.

In some embodiments, the sintered electrode includes a first phase and trace, non-significant, quantities of a second phase.

One advantage of the sintered electrodes disclosed herein is that they can be made larger than conventional electrode materials for batteries, such as those made using thin-film techniques. In embodiments, the sintered electrode has a thickness of from 2 μm to 150 μm, or from 5 μm to 150 μm, or from 20 μm to 80 μm, or from 30 μm to 60 μm, or any value or sub-range disclosed therein. Besides being thicker than thin-film electrodes, the sintered electrode can also be made with a relatively larger cross-sectional area. In embodiments, the sintered electrode has a cross-sectional area of at least 3 cm², or at least 10 cm², or at least 100 cm², or up to 1 m², or any value or sub-range disclosed therein.

The sintered electrode is able to be made larger than conventional thin-film electrodes because the electrode is formed from a tape cast or extruded green tape that is rapidly sintered. In order to form the green tape, a slurry (or paste) is prepared from a powder component, a binder, and a solvent. The powder component includes a powdered compound or powdered compounds containing a lithium-, sodium-, or magnesium-based compound and at least one alkali metal or alkaline earth metal. The powdered compounds containing the lithium-, sodium-, or magnesium-based compound and the alkali metal or alkaline earth metal may be a single powdered compound. Alternatively or additionally, the compounds can include a lithium-, sodium-, or magnesium-based compound and a separate compound containing an alkali metal or alkaline earth metal. Further, in embodiments, the powdered compound can further contain a transition metal along with or in a separate compound from the lithium-, sodium-, or magnesium-based compound and the compound containing an alkali metal or alkaline earth metal.

For example, with respect to a lithium electrode, the powdered compound may comprise lithium and a transition metal, such as LCO or LMO. In another example, one compound can contain the lithium compound and the compound containing an alkali metal or alkaline earth metal, and another compound can contain a transition metal. For example, with respect to a lithium electrode, the lithium compound can be at least one of Li₂O, Li₂CO₃, LiOH, LiNO₃, lithium acetate (CH₃COOLi), or lithium citrate (Li₃C₆H₅O₇), among others, and the transition metal-containing compound can be at least one of MnO₂, Mn₂O₃, Co₂O₃, COO, NiO, Ni₂O₃, Fe₂O₃, Fe₃O₄, FeO, TiO₂, Nb₂O₅, V₂O₅, VO₂, Ta₂O₅, or WO₃. In embodiments, the powder component of the slurry or paste (including all powdered compounds) comprises from 40% to 75% by weight of the slurry (or paste). In other embodiments, the powder component comprises from 45% to 60% by weight of the slurry (or paste), and in still other embodiments, the powder component comprises from 50% to 55% by weight of the slurry (or paste).

The slurry (or paste) is provided with a binder that holds the powder component together in the form of the green tape prior to sintering. In embodiments, the binder is at least one of polyvinyl butyral (PVB) (e.g., Butvar® PVB resins, available from Eastman Chemical Company), acrylic polymers (e.g., Elvacite® acrylic resins, available from Lucite International), or polyvinyl alcohol, among others.

The slurry (or paste) is also provided with a solvent in which the powder component and binder are dispersed. In particular, the solvent is selected so as to avoid leaching the alkali metal or alkali earth metal from the lithium-, sodium-, or magnesium-based compounds in the slurry. Table 1, below, demonstrates leaching characteristics for two solvents with respect to lithium ions, non-polar 1-methoxy-2-propanyl acetate (MPA) and a polar ethanol-butanol mixture. In investigating the leaching characteristics of the two solvents, 200 g of the powdered electrode material identified in Table 1 were mixed with the 200 g of the solvent. The mixture was centrifuged, and the decanted liquid was analyzed for its lithium concentration via induction coupled plasma (ICP) spectroscopy. As shown in Table 1, the polar ethanol-butanol mixture contained a much greater concentration of lithium than the non-polar MPA. Such leaching of the lithium from the ceramics (e.g., LCO, LMO, etc.) can occur as the result of ion exchange or the formation of hydroxides. Once the lithium enters the solvent, there can be several unwanted side-effects. For example, the solubility of the binder may be reduced. Further, the dissolved lithium may interfere with dispersants. Still further, the dissolved lithium may migrate during drying, which may lead to chemical inhomogeneity in the dried tape. Additionally, the chemistry of the inorganic particles themselves is altered. Moreover, reaction with the solvent is time dependent so the slip properties are subject to continuous change and a potentially unstable process.

TABLE 1
Leaching of lithium from electrode material
in non-polar and polar solvents.

| electrode | | Li Concentration |
|---|---|---|
| Material | Solvent | (×10⁻⁶ mg/L) |
| LMO | MPA | <0.005 |
| LMO | MPA | <0.005 |
| LMO | Ethanol- Butanol Mixture | 1.61 |
| LMO | Ethanol- Butanol Mixture | 1.77 |
| LCO | MPA | <0.005 |
| LCO | MPA | <0.005 |
| LCO | Ethanol-Butanol Mixture | 2.05 |
| LCO | Ethanol-Butanol Mixture | 2.28 |

Accordingly, in embodiments, the solvent is selected to be non-polar. In particular embodiments, the non-polar solvent has a dielectric constant at 20° C. of less than 20. In other embodiments, the non-polar solvent has as dielectric constant at 20° C. of less than 10, and in still other embodiments, the non-polar solvent has a dielectric constant at 20° C. of less than 5. Further, in embodiments, the solvent leaches less than 1 ng/L of the alkali metal or alkaline earth metal from the powder component in the slurry. In other embodiments, the solvent leaches less than 0.1 ng/L of the alkali metal or alkaline earth metal from the powder component in the slurry, and in still other embodiments, the solvent leaches less than 0.01 ng/L of the alkali metal or alkaline earth metal from the powder component in the slurry.

In embodiments, the chemistry of the binder may be adjusted to work with non-polar solvents, such as MPA. For example, Butvar® B-79 is a commercially available PVB that has a low concentration of hydroxyl groups from polyvinyl alcohol (11-13% by weight) and, compared to other PVB binders, has a low molecular weight. This allows for ease of dissolution and high solubility to control viscosity and enable a high loading of solids.

In embodiments, that slurry (or paste) may contain other additives that aid in processing. For example, in embodiments, the slurry (or paste) may contain between 0.1% to 5% by weight of a dispersant and/or of a plasticizer. An exemplary dispersant is fish-oil dispersant, and an exemplary plasticizer is dibutyl phthalate. Further, as will be discussed more fully below, the presence of transition metal oxides in the slurry (or paste) can cause a catalytic combustion reaction during sintering. Thus, in embodiments, the slurry (or paste) may contain additives to prevent or reduce the severity of such combustion reactions. In particular, the slurry (or paste) may contain an antioxidant, such as a phenol (e.g., butylated hydroxytoluene (BHT) or alkylated-diphenylamine), or materials with an endothermic decomposition like inorganic carbonates and hydroxides.

The slurry (or paste) is tape cast or extruded into a green tape having the desired thickness of the sintered electrode. As discussed above, the thickness may be in the range of from 2 μm to 150 μm. In embodiments, the green tape is dried to remove a substantial portion of the solvent, leaving primarily the lithium-, sodium-, or magnesium-based compound containing the alkali metal or alkaline earth metal. In embodiments, drying may occur at ambient temperature or at a slightly elevated temperature of 60° C. to 80° C. (or begin at an ambient temperature and transition to an elevated temperature). Additionally, in embodiments, air is circulated to enhance drying. In embodiments, the amount of organic material remaining after drying is no more than 10% by weight of the dried green tape. Upon drying the green tape is debound and sintered. That is, the green tape is heated to a temperature at which the polymer binder and any other organics are burned off. In embodiments, debinding occurs in the temperature range of 175° C. to 350° C. Thereafter, the dried and debound green tape is sintered. Sintering occurs in the temperature range of 500° C. to 1350° C. Sintering time in this temperature range is less than 60 minutes. In embodiments, sintering time is less than 50 minutes, and in still other embodiments, sintering time is less than 45 minutes. Upon sintering, the sintered electrode has a porosity of no more than 30%. In embodiments, the sintered electrode tape has a porosity of no more than 25%. In other embodiments, the sintered electrode has a porosity of no more than 20%, and in still other embodiments, the sintered electrode has a porosity of no more than 15%. In embodiments, the porosity of the sintered electrode is at least 0.1%. As a result of the sintering process, in embodiments, the sintered electrode has on average a grain size of from 10 nm to 50 μm. In other embodiments, the grain size on average is from 50 nm to 10 μm, and in still other embodiments, the grain size on average is from 100 nm to 1000 nm.

Further, in embodiments, the sintered electrode has an open porosity such that fluid communication is provided between a first surface of the sintered electrode to the other surface. That is, in embodiments, the lithium-, sodium-, or magnesium-based compound phase comprises a solid phase, and the porosity comprises a second phase in which the second phase is a continuous phase in the solid phase. Additionally, in embodiments, the pores of the sintered electrode tape are substantially aligned to promote ion transport. That is, the pores are aligned along an axis perpendicular to the first and second surfaces. For example, each pore may have a cross-sectional dimension that is longer than any other cross-sectional dimension of the pore, and the longer cross-section dimension is substantially aligned perpendicularly to the first and second surfaces of the electrode, e.g., on average, aligned to within 25° of perpendicular. Advantageously, in contrast to other sintered electrodes, the sintering process described produces a sintered electrode that requires no further finishing, such as mechanical grinding or polishing, prior to incorporating into a battery architecture. In particular, previous sintered electrodes were formed from large discs at much greater thicknesses, e.g., 500 μm to 1 mm, and had to be diced to usable dimensions and ground down to a usable thickness. Such grinding has reportedly only been able to achieve a thickness of about 130 μm, which is the practical limit for electrodes manufactured according to such processes. By tape-casting the electrode, not only is the process made more economical (e.g., no grinding/polishing steps and ability to utilize roll-to-roll fabrication), but also desirable thicknesses of the electrode material can be achieved.

Further, because the sintered electrode is self-supporting, the sintered electrode can be used as a substrate for deposition of additional layers. For example, a metallic layer (e.g., up to 5 μm) can be deposited onto a surface of the sintered electrode to serve as a current collector for a battery. Additionally, in an exemplary embodiment, a solid electrolyte, such as lithium-phosphorous-oxynitride (LiPON), lithium garnet (e.g., garnet LLZO (Li₇La₃Zr₂O₁₂)), or lithium phosphosulfide, may be deposited by RF-sputtering onto the sintered electrode. Alternatively, a thin layer of LiPON solid electrolyte can be applied through ammonolysis of a thin layer of Li₃PO₄ or LiPO₃ or through reactive sintering. Such processes are envisioned to be faster and potentially less capital intensive than conventional deposition techniques for solid electrolytes. Similarly, a solid electrolyte of lithium garnet (e.g., LLZO) can be applied by sol-gel, direct sintering, and reactive sintering.

Further, as a self-supporting layer, the sintered electrode can provide the basis for an advantaged manufacturing approach for lithium batteries that use a liquid electrolyte. In other words, the cathode (i.e., sintered electrode) is a substrate of the battery. In particular, the sintered electrode can be made in a continuous process and used as a substrate for coating in either batch or roll-to-roll processing. Such processing could allow, for example, metallization of the sintered electrode by sputtering and/or electrolytic deposition to form a metallized sintered electrode. In this way, the thickness of the electrode current collector metal can for a conventional lithium battery can be reduced from the typical thickness of 10-15 μm to less than 5 μm, less than 1 μm, or even less than 100 nm. Further, the metallized sintered electrode can be supplied in piece or roll form as a stand-alone component to a battery cell manufacturer. Advantageously, such metallized sintered electrodes reduce the volume of the cell typically reserved for the current collector, allowing for more active electrode material and higher capacity.

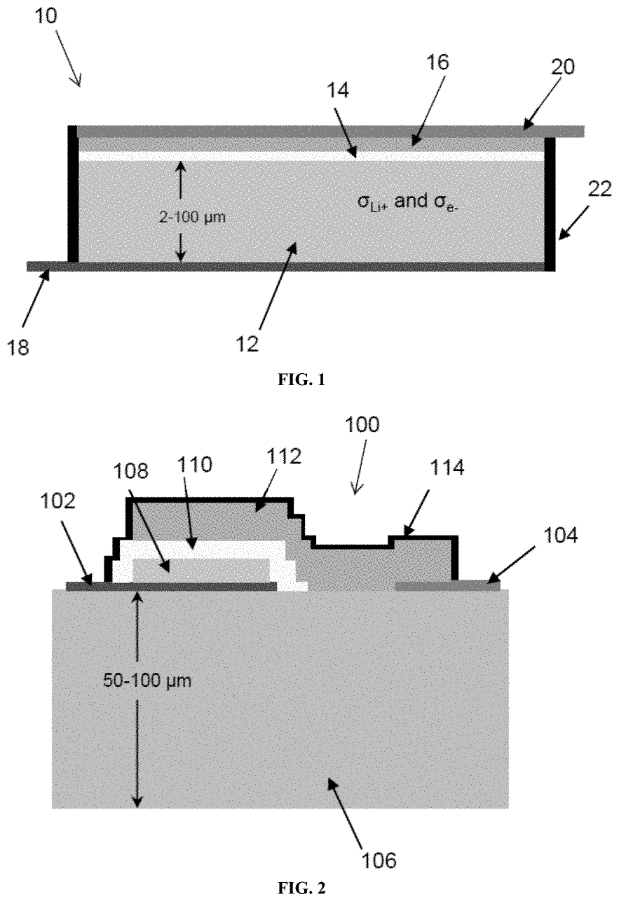

In this regard, the sintered electrode is particularly suitable for use in ion intercalation type batteries. An exemplary embodiment of a lithium-ion battery 10 is shown in FIG. 1. The lithium-ion battery 10 includes a sintered cathode 12, an electrolyte layer or region 14, and an anode 16. In embodiments, the sintered cathode 12 has a thickness of from 2 μm to 150 μm. Additionally, in embodiments, the sintered cathode 12 has a cross-sectional area of at least 3 cm². Advantageously, the sintered cathode 12 mechanically supports the lithium-ion battery 10 such that the sintered cathode 12 is not carried on a mechanical support, such as a zirconia support. The advantage of this architecture is that inactive components are substantially excluded from the battery. That is, while providing the function of a mechanical support, the sintered cathode 12 is still an active component and contributes to the capacity of the battery. Accordingly, the cathode-supported design can give the same overall capacity in a thinner form-factor, or the thickness of the cathode can be increased for a higher net capacity at the same size.

Further, the sintered cathode 12 can be used in both solid-state and liquid electrolyte lithium-ion batteries. In particular, in a solid-state battery, the electrolyte layer 14 includes a solid-state electrolyte (e.g., having a conductivity of >10⁻⁶ S/cm), such as LiPON, lithium garnet (e.g., LLZO), or lithium phosphosulfide. More particularly, in a solid-state battery, the electrolyte layer 14 includes a solid electrolyte, such as LiPON, lithium garnet (e.g., LLZO), lithium phosphosulfide, or lithium super ionic conductor (LISICON), with a combination of lithium ion conductivity and thickness such that the area specific resistance is less than about 100 Ωcm². One advantage of LiPON, in particular, is that it is resistant to dendrite formation. In a liquid electrolyte battery, the electrolyte layer 14 includes a liquid electrolyte, such as LiPF₆-DMC (lithium hexafluorophasophate in dimethyl carbonate), and a polymer or ceramic separator to separate the cathode 12 and anode 16. In either case, the sintered cathode 12 increases the charge capacity over conventional lithium-ion batteries.

The battery 10 also includes a first current collector 18 disposed on a first surface of the sintered cathode 12. In the embodiment depicted, a second current collector 20 is disposed on the anode 16; however, in embodiments, the anode may be a metal (such as lithium metal or magnesium metal) in which case a current collector may be excluded. Further, in the embodiment depicted, the battery 10 is encased in a protective coating 22. In embodiments, the first current collector 18 is copper, and the second current collector 20 (when used) is aluminum. The protective coating 22 may be, e.g., parylene.

While the depicted embodiment only includes a sintered cathode 12, the anode 16 may also be a sintered electrode according to the present disclosure. For a lithium-ion battery, the (sintered) cathode 12 may include at least one of lithium cobaltite, lithium manganite spinel, lithium nickel cobalt aluminate, lithium nickel manganese cobalt oxide, lithium iron phosphate, lithium cobalt phosphate, lithium nickel manganate, or lithium titanium sulfide, and the (sintered) anode 16 may include at least one of lithium titanate or lithium niobium tungstate.

Additionally, while a lithium-ion battery is depicted, the battery could instead be based on sodium-ion, calcium-ion, or magnesium-ion chemistries. For a sodium-ion battery, the (sintered) cathode 12 may include at least one of NaMnO₂, Na_{2/3}Mn_{1-y}Mg_{y}O₂ (0<y<1), or NaVPO₄F, and the (sintered) anode 16 may include at least one of Na₂Li₂Ti₅O₁₂ or Na₂Ti₃O₇. For a magnesium-ion battery, the (sintered) cathode 12 may include at least one of MgCr₂O₄ or MgMn₂O₄, and the anode 16 may magnesium metal (which could also serve as the current collector 20). Any of the foregoing battery chemistries may utilize a liquid electrolyte comprising a solvent (e.g., DMC) and a salt with a cation matching the intercalant ion. Additionally, for a sodium-ion battery, sodium super ionic conductor (NASICON) may be used as a solid-state electrolyte.

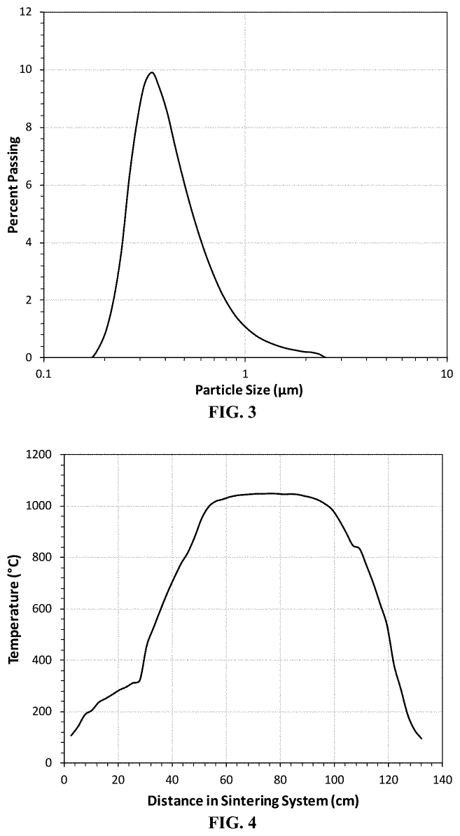

For the purposes of demonstrating the gain in capacity, FIG. 2 provides a schematic cross-section of a conventional solid-state, thin-film micro-battery 100. The micro-battery 100 includes a cathode current collector 102 and an anode current collector 104 deposited onto an inert mechanical support 106. A cathode 108 (e.g., LCO or LMO) is formed onto the cathode current collector 102 and is surrounded by a solid-state electrolyte 110 (e.g., LiPON). An anode 112 is deposited over the electrolyte 110 and over the anode current collector 104. A coating 114 is provided to protect the cathode 108, electrolyte 110, and anode 112. In the conventional battery design, the mechanical support 106 is relied upon for handling during fabrication of the battery 100 and is the platform for the deposition of the cathode 108 and electrolyte 110 layers. The mechanical support 106 typically has a thickness of 50 μm to 100 μm. The mechanical support 106 and the protective coating 114 also provide rigidity in the final package and help prevent damage.

In these conventional batteries 100, the cathode 108 is typically grown to desired thickness by processes such as RF sputtering or pulsed laser deposition. These deposition techniques are another reason why the conventional battery 100 requires the use of mechanical support 106. Such conventional methods produce cathode materials at a rate of <10 μm/hr, which creates a practical and commercial limit to the achievable thicknesses of these conventional cathode materials. As a consequence, thin film micro-batteries have only found applications where small size power sources are needed like smart cards, medical implants, RFID tags, and wireless sensing.

A comparison of the charge capacity of battery 10 of FIG. 1 according to the present disclosure and the charge capacity conventional battery 100 of FIG. 2 is made at nominally identical thicknesses of 80 μm. In particular, the comparison is made between (1) a conventional battery 100 having a 50 μm thick mechanical support 106 of zirconia and a cathode that is 5 μm thick and (2) the presently disclosed battery 10 having a cathode 12 that is 35 μm thick. Notably, the thickness of the cathode 12 of the presently disclosed battery 10 is less than the thickness of the mechanical support 106 of the conventional battery 100, allowing space to be reserved for lithium metal at the anode 16. The extra thickness of the sintered cathode 12 and removal of the mechanical support 106 provides a seven-fold higher capacity in absolute and volumetric terms, and the capacity is ten-fold greater on a weight basis.

Besides simply allowing for a larger electrode, the sintered cathode 12 of the depicted embodiment also provides structural advantages that increase its charge capacity over conventional cathodes. In a conventional cathode 108, the active cathode particles make point contacts. The cross-sectional areas of the contacts are small and so have a high impedance to movement of lithium ions and electrons. In order to overcome this impedance issue, carbon is added to the electrode as a conductive pathway to facilitate transport of electrons into and out of the active particles, and pore space in the electrodes are infiltrated with liquid electrolyte for fast conduction of lithium ions. The use of carbon in this manner creates a tradeoff between capacity of the batter and charge/charge rate performance. The other issue with the point contacts between the active cathode particles is that they are weak, and so polyvinyl fluoride (PVF) is used to bind the active particles and carbon together to give the structure strength during processing. In contrast, particles in the depicted sintered cathode 12 are bonded to one another, and so, the electronically conductive carbon and binder may be eliminated. In this way, the proportion of space allocated to porosity for movement of lithium ions may be reduced, and more space can be dedicated to active material with a sintered cathode. The inventors estimate that for a given cathode material, the capacity in aggregate can be raised by approximately 30% on the basis of equal cathode thicknesses. Alternatively, the cathode thickness could be reduced by 20-25% while keeping the capacity the same for a more compact battery. As mentioned above, the pores in the sintered cathode 12 can be aligned in the direction of transport of ions to and from the anode so as to enable further improvements in space utilization or to boost power density.

The present application discloses self-supporting sintered cathodes with a layered rock-salt structure (e.g., lithium cobaltite, LCO) and nickel-based materials (e.g., lithium nickel cobalt aluminate, NCA; lithium nickel manganese cobalt oxide, NMC) that have electronic conductivity greater than 10⁻⁵ S/cm or greater than 10⁻⁴ S/cm at room temperature.

As used herein, the phrase “self-supporting” refers to a structure that is not adhered or supported by an underlying substrate (i.e., inert mechanical support). In some examples, self-supporting sintered electrodes are free-standing, which can be mechanically manipulated or moved without need of a substrate adhered or fixed thereto and which can itself be used as a substrate for deposition of additional layers. Thus, for the embodiments described herein, a self-supporting sintered electrode serves a dual function of being a support upon which additional energy storage elements (e.g., electrolyte layer, current collector, etc.) may be disposed and being an active component (e.g., cathode or anode) of the battery. As used herein, the phrase “cross-sectional area” refers to a cathode surface area that may be used to support construction of a battery structure. For example, with reference to FIG. 1, the cross-sectional area of sintered cathode 12 is defined by the horizontal length (e.g., width) of the cathode (measured as the length between protective coating 22) and the depth of the cathode (into the page).

In some examples, the cathode can be fully dense, containing pores that are closed or open, and have open porosity of up to 30%. The sintered cathode can have a thickness of 5 to 150 μm. The process for making cathodes with this conductivity require at least 1 min and up to 1 hour of residence time in an atmosphere of at least 5 vol. % oxygen at temperatures between 400° C. and 825° C. after sintering. Residence time may be provided as a hold during cooling from the high temperature sintering process or conducted as a separate processing step.

The increased electronic conductivity has benefits to cell performance battery making processes. For example, increased conductivity reduces internal resistance of a battery, thereby enabling faster charging and delivery of greater power. Increased conductivity also allows thicker electrodes to be utilized, which are advantageous for cathode fabrication and battery assembly. Battery capacity is controlled by mass of active electrode material. In contrast, rates of sheet making process are dictated by area. In other words, the same amount of area can be made regardless of the thickness of the sheet. Hence, a given capacity of cathode can be made in less time if it is thicker. Use of a thinner cathode for rate performance implies assembly of more layers of single cells to build a battery of a given capacity. The number of assembly steps to make a battery with thicker cathodes can be reduced, leading to lower cost.

### EXAMPLES

A critical step in battery operation for rapid charging and delivery of power is transport of electrons to and from interfaces, as needed, for reduction and oxidation reactions, respectively. Because the active material in cathodes comprising layered rock-salt structured cathode materials (e.g., LCO, NMC, etc.) is present as particles which are either isolated or which make only point contacts, effective conductivity is low (e.g., <10⁻⁵ S/cm). Point contacts indicate that active material particles contact each other at touchpoints, thereby creating large pore spaces and making effective conductivity low.

Traditional methods add a carbon conductor to bridge the gap such that electronic conductivity of such composite cathodes increases to about 10⁴ to 1 S/cm, which is much higher than that of the liquid electrolyte (10⁻³ to 10⁻⁴ S/cm) and lithium ions (>10⁻⁷ S/cm) in the active cathode material. However, such solutions are often difficult and impractical to add a secondary conducting phase like carbon into a sintered structure. In addition, it would also sacrifice energy density.

The present disclosure presents cathode-supported architectures comprising cathode materials with layered rock-salt materials such as LCO, LNO, NMC, and NCA which have an electronic conductivity faster than lithium ion conduction. Particles are sintered to one another and form large cross-sections whereby the intrinsic conductivity can be realized. As a result of particle sintering, it is difficult and impractical to add a secondary conducting phase like carbon into the sintered structure and doing so, would also sacrifice energy density. Rapidly sintered cathodes of LCO, despite having a correct nominal composition and crystal structure, have an electronic conductivity that is four orders of magnitude lower than published room temperature values. The electronic conductivity can be lower than rate of conduction of lithium ions, thereby limiting practical capacity and rate performance in a battery.

The present application determines that a cause of the low conductivity is linked to rapid processing steps and that the high conductivity may be restored with a short heat treatment, preferably in an atmosphere containing at least 5 vol. %, or at least 10 vol. %, or at least 20 vol. % oxygen. Components of the heat treatment atmosphere may also include air, nitrogen, or argon or mixtures thereof.

### Example 1—Cathode Preparation and Characterization

Rapidly sintered, self-standing cathodes were prepared starting with lithium cobaltite purchased from American Elements. The powder is nominally stoichiometric and XRD shows that it is single phase with peak positions and intensities consistent with layered rock-salt structures. The as-received powder was attrition milled to break agglomerates into dispersible particles with size required for sintering. Attrition milling was performed with a Union Process Mill in a batch mode and a 1 L milling jar. The charge into the mill was 2600 g of 2 mm diameter zirconia media, 400 g of as-received LCO powder, and 360 mL of isopropyl alcohol. The mill was stirred at 2000 rpm for 3 hr. A typical mean particle size after milling is between 0.35 to 0.45 μm, and a particle size distribution (varying primarily between 0.2 μm and 1.1 μm) is presented in FIG. 3, which illustrates particle size distribution of LCO powder after attrition milling in ceramic tape formation.

The powder and media were dried together and separated by sieving.

Ceramic tapes for rapid sintering were cast using the milled LCO powders. The total concentration of binder and non-volatile organics were determined to control flammability of the tape and ensure it can be de-bound at a reasonable speed in the rapid sintering process. Slip composition comprised 58-60% LCO, 2.7% Butvar B76 polyvinyl butyral, 0.8% Hypermer KD1 dispersant, 0.8% dibutyl phthalate dispersant blended with a mixture of methyl ethyl ketone and toluene. The LCO was dispersed in the methyl ethyl ketone and toluene mixture prior to addition of binder by light milling. The slip was cast into green tape with two thicknesses, 35 μm and 25 μm, to target fired thicknesses of about 25 and 20 μm, respectively. The width was 100 mm in both cases. The carrier used for casting was polyethylene terephthalate coated with silicone to facilitate release of the LCO tape.

Rapid sintering of the LCO tape to make cathodes was performed by:

(1) Green LCO tape while still on the carrier was manually cut into 300-400 mm long and 50-60 mm wide strips using scissors. The tape was manually released from the carrier.

(2) An 80 μm thick ribbon of alumina that is approximately 3 m long was threaded through a 1 m long muffle furnace operating at 1050° C. and then through an adjacent binder burn-out apparatus consisting of two opposed air bearing and onto a platform. The binder burn-out apparatus is approximately 300 mm long and has multiple heating zones that were programmed to give a linear temperature ramp between 225° C. at the entrance and 325° C. at its exit and interface with the muffle furnace. Air bearings were previously carefully aligned with an alumina “D” in the muffle furnace. The purpose of the “D” is simply to provide a flat surface for the alumina ribbon or cathode tape.

(3) The strip of LCO tape was placed carefully onto the alumina ribbon such that the long axis of each were centered. The alumina ribbon with the LCO tape was pulled at 63.5 mm/min through the binder-burn-out zone, then through the muffle furnace for sintering, and then out onto a platform at room temperature where it was collected. Cathode disks with a diameter of 12.3 mm were laser cut from the sintered LCO ribbon.

FIG. 4 illustrates temperature profile of the LCO tape in rapid sintering apparatus starting from the entrance of the binder burn out zone. Sintering of the LCO ribbon is completed in just over 20 min. The LCO tape may be automatically released from the carrier and pulled directly through the binder burn-out apparatus and through the muffle furnace for roll-to-roll sintering of cathode ribbon. No alumina ribbon for conveyance is needed in this arrangement. The tape and ribbon, because they are thin and flexible, twist rather than break in response to the large temperature gradients. The process used herein imparts the same thermal history into the sintered LCO ribbon.

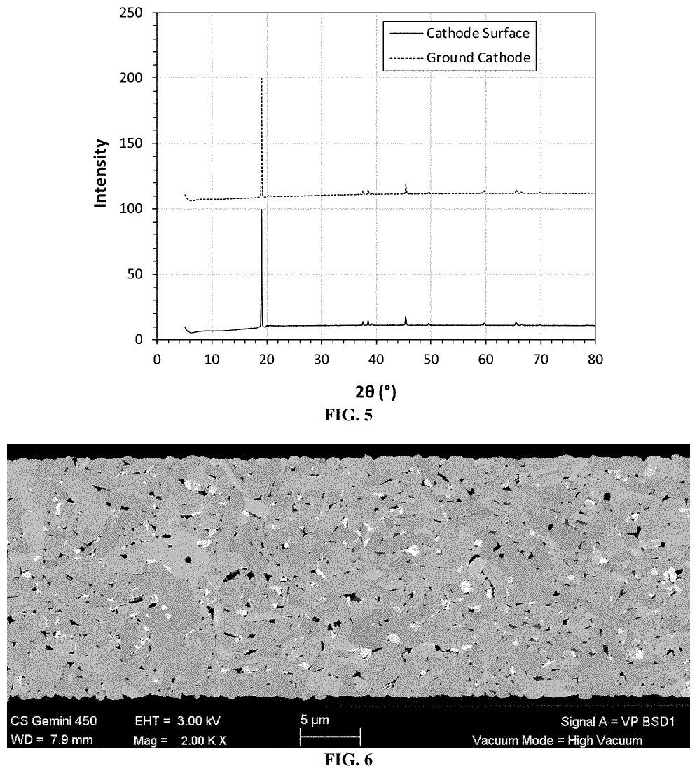

The rapidly sintered cathodes (at 1050° C.) made by the process are single phase LCO, as shown by X-ray diffraction (XRD) traces of as-fired surface and after grinding of the disk to a powder (ground cathodes) in FIG. 5. There are no secondary phases based on CoO or Co₃O₄ detected, as in conventional composite LCO cathodes.

FIG. 6 illustrates a polished scanning electron microscopy (SEM) cross-section image of a representative cathode disk, which is structurally flat and 19.5 μm in thickness. Porosity is determined by image analysis to be less than about 3%, indicating a closed-pore structure. Small (i.e., trace) quantities of secondary phase (zirconia-rich and entering the LCO during the milling process due to self-attrition of the grinding media) are present and detected by bright white contrast.

### Example 2—Electronic Conductivity

A few nanometers of gold metallization were deposited through 9 mm masks placed roughly concentrically on opposing faces of the cathode disks by sputtering using a benchtop Electron Microscopy Sciences instrument. The metallization serves as blocking electrodes for determination of electronic conductivity separate from ionic conductivity. Resistance of the metallized cathode was measured with a simple hand-held multimeter. To make the measurement, the cathode disk was laid on a conductive metal support. The tip of one multimeter probe was contacted with the support while the other tip was used to gently press on the upper metallization of cathode and form a contact with the support. The electronic conductivity was obtained according to the equation σₑ=t/(R A) where R is the resistance of the cathode, t is the thickness of the cathode, and A is the area of the gold metallization.

The electrical conductivity of as-fired LCO cathodes was between approximately 10⁻⁸ S/cm and 10⁻⁷ S/cm. As discussed above, this value is lower than those reported in literature by roughly four orders of magnitude and is likely to cause a bottleneck on rate performance if the cathodes were used in battery applications (whether in combination with solid-state electrolytes or liquid electrolytes). It was unexpectedly found that treatment of cathodes for short times in air at 750° C. to 850° C. (e.g., 800° C.) results in a dramatic increase in electronic conductivity. In some embodiments, treatment of the sintered cathodes may be conducted for a time in a range of 5-60 min or 1-30 min or 5-45 min in an atmosphere containing 5-70 vol. % O₂ or >0-25 vol. % O₂ or >50 vol. % O₂ (with balance being a non-reactive gas).

### Example 3—Process and Product Improvement

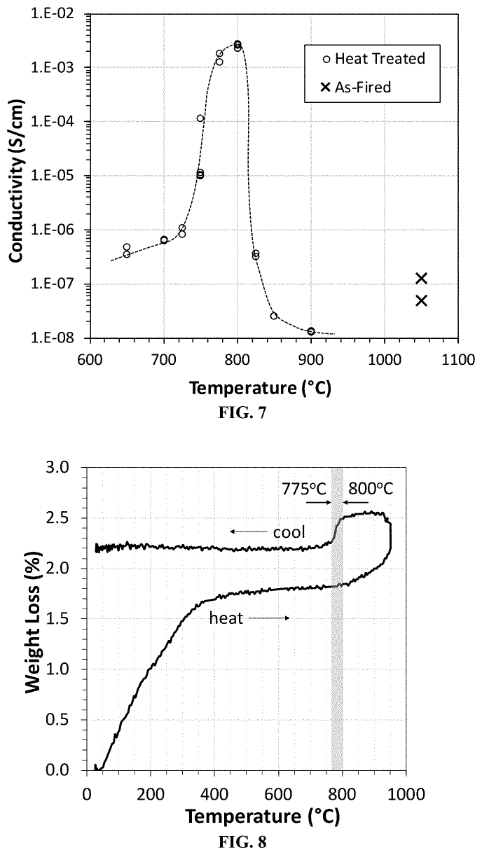

Further studies show an unexpectedly narrow temperature window where the electronic conductivity dramatic increases. FIG. 7 illustrates electrical conductivity of LCO as-fired and as a function of heat treatment temperature for a fixed treatment time of 10 min and a fixed atmosphere of 20 vol. % 02 and 80 vol. % Ar. Heat treatment was conducted by pushing the cathodes into a hot zone of a muffle furnace at 102 mm/min, holding for the defined time of 10 min, and immediately withdrawing them at the same speed. As can be seen in FIG. 7, conductivity increases rapidly as the heat treatment temperature is lowered below 825° C., passes through a maximum of about 3×10⁻³ S/cm at 775° C. to 800° C., and then drops quickly at lower temperatures to values less than 10⁻⁴ S/cm.

A weight change in the narrow temperature range of 775° C. to 800° C. where the heat-treatment restores high electronic conductivity is observed in thermogravimetric analysis (TGA) of LCO powder. FIG. 8 illustrates TGA analysis of LCO powder in air where a change in weight is calculated as a function of temperature for heating and cooling in air. A weight loss of about 0.5% at 950° C. is observed, followed by a weight gain on cooling of about 0.15-0.25% near 800° C. These two events are consistent with thermal reduction on heating followed by re-oxidation on cooling of cobalt in the LCO. Weight change as in FIG. 8 is a physical demonstration of a gain in weight due to uptake of oxygen by the cathode during the heat treatment.

The effect of oxygen concentration for constant heat treatment temperature and time of 800° C. for 10 min was explored to test whether high temperatures like 1050° C. used for sintering leads to some thermal reduction of the cobalt in the LCO.

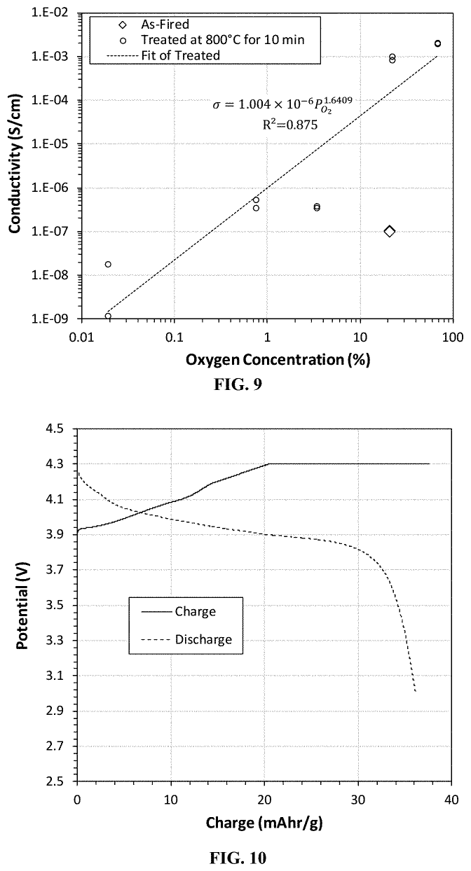

The temperature of the LCO ribbon then drops by approximately 700° C. in just 3 min as the LCO ribbon moves from the hot-zone and out of the sintering furnace at a speed of 63.5 mm/min, see FIG. 4. The fast cooling quenches in the reduced, low conductivity state. Heat treatment in 20 vol. % oxygen permits re-oxidation. FIG. 9 illustrates electrical conductivity of LCO as-fired and as a function of oxygen concentration for a fixed heat treatment temperature of 800° C. and time of 10 minutes and argon (Ar) as a make-up gas. The relationship supports the mechanism. Conductivity decreases to below 10⁻⁴ S/cm for cathodes treated in the lowest oxygen concentration, about 200 ppm. In fact, the conductivity is lower than in the as-fired state, suggesting that not only does the cobalt not re-oxidize, but that it may actually be further reduced. Conductivity then increases progressively with oxygen concentrations up to at least 70 vol. % and reaches a value above 10⁻⁴ S/cm.

Moreover, low electronic conductivity in rapidly sintered LCO is due to a quenched in and reduced high temperature state comes from measuring electronic conductivity of LCO as a function of temperature up to 700° C. in air, 1 vol. % oxygen and argon gas. This measurement shows that electronic conductivity is lower under the reducing argon gas atmosphere at 700° C., and the electronic conductivity decreases at a faster rate on cooling than in an air atmosphere. The room temperature conductivity of LCO measured in argon is 10⁻⁴ S/cm versus 10⁻³ S/cm in air. Although rapidly sintered LCO cathodes that are the subject of this disclosure are fired in air, the high temperatures of 1000-1100° C. are likely to induce thermal reduction similar to what occurs under argon gas at lower temperatures.

### Example 4—Coin Cell Tests, Capacity, and Rate Performance

Coin cell tests were conducted to demonstrate the importance of electrical conductivity of the cathode to rate performance. Coin cells with the 2032 design were constructed. The cell assemblies consisted of the following components in sequence of stacking: an anode cap; a wave spring, 1.5 mm in height in the uncompressed state; a 15 mm diameter and 0.5 mm thick stainless steel separator; a 14 mm diameter and 0.3 mm thick chip of lithium as the anode; a 17 mm diameter and 90% porous Whatman glass fiber separator (GF/A 1820-915); a sintered cathode disk coated with a gold metallization; a 15 mm diameter and 0.3 mm thick stainless steel spacer; and a cathode cap

Gold metallization was applied to the sintered cathodes after any heat treatments and immediately before assembly into a coin cell. The gold side was placed facing the stainless steel separator to aid in forming a low resistance contact. The electrolyte used in the cells was a 1 M solution of LiPF₆ in a 1:1 mixture of ethylene carbonate and dimethyl carbonate solution. The electrolyte was applied with an automated pipette in three steps of 50 μm each, one dispensed on the anode chip, one on the Whatman fiber separator, and one to the cathode. Finally, the components were chosen based upon thicknesses to provide 15 to 30% of compression on the wave spring after crimping.

Charging of the cells was performed first at a constant current density of 0.0906 mA/cm² up to 4.3 V. The cells were then charged at constant voltage until the current density attenuated to 0.00906 mA/cm². Each cell was then discharged to 3.0 V at the same current density. Three cycles were applied to each and the third cycle is taken as representative of steady-state behavior.

To make the connection between electrical conductivity and battery rate performance, resistance measurements and coin cells tests were conducted on pairs of sintered cathodes that are otherwise identical neglecting slight differences in weight. In other words, they were cut from the same ribbon and processed identically and together for each set of process conditions. The cathodes for resistance measurements and coin cells tests are listed in Tables 2 and 3, respectively, for four types of heat treatment condition. Two of the conditions—none, and 800° C. for 10 min in a mixture of 0.02 vol. % 02 and 99.98 vol. % Ar—were selected for low electrical conductivity. In the other two conditions—800° C. for 1 hr in air (21 vol. % O₂), and 800° C. for 10 min in a mixture of 69 vol. % 02 and 31 vol. % Ar—the cathodes were treated in an oxygen rich atmosphere to induce high electrical conductivity. The electrical conductivity of the cathodes as can be seen in Table 2 span over six orders of magnitude.

TABLE 2
Details for cathodes used for determination of electronic conductivity

| Cathode Attributes | R1a | R1b | R2a | R2b | R3 | R4 |
|---|---|---|---|---|---|---|
| Post-Sinter Heat | None | | 800° C./1 hr in air | | 800° C./10 min in 0.02 vol. % | 800° C./10 min in 69 vol. % |
| Treatment Conditions | | | (21 vol. % O₂) | | O₂ and 99.98 vol. % Ar | O₂ and 31 vol. % Ar |
| Resistance (Ω) | 171,000 | 183,000 | 7.8 | 7.2 | 3.4 × 10⁶ | 1.9 |
| Mass (g) | 0.0116 | 0.0118 | 0.0116 | 0.0116 | 0.0144 | 0.0144 |
| Thickness (μm) | 19.3 | 19.7 | 19.3 | 19.3 | 25.5 | 25.5 |
| Conductivity (S/cm) | 1.8 × 10⁻⁸ | 1.7 × 10⁻⁸ | 3.9 × 10⁻⁴ | 4.2 × 10⁻⁴ | 1.16 × 10⁻⁹ | 1.99 × 10⁻³ |

TABLE 3
Details for cathodes used in construction of 2032 coin cells and cell capacity

| Cathode Attributes | C1a | C1b | C2a | C2b | C3 | C4 |
|---|---|---|---|---|---|---|
| Cathode mass (g) | 0.0115 | 0.0116 | 0.0116 | 0.0116 | 0.0139 | 0.0139 |
| Thickness (μm) | 19.2 | 19.3 | 19.3 | 19.3 | 23.2 | 23.2 |
| Post-Sinter Heat | None | | 800° C./1 hr in air | | 800° C./10 min in 0.02 vol. % | 800° C./10 min in 69 vol. % |
| Treatment Conditions | | | (21 vol. % O₂) | | O₂ and 99.98 vol. % Ar | O₂ and 31 vol. % Ar |
| Capacity on charging | 20.5 | 18.3 | 103.7 | 100.1 | 17.7 | 77.7 |
| to 4.3 V (mAh/g) | | | | | | |
| at 0.0906 mA/cm² | | | | | | |
| Capacity on discharging | 36.1 | 30.6 | 104.5 | 105.1 | 36.6 | 89.4 |
| to 3.0 V (mAh/g) | | | | | | |
| at 0.0906 mA/cm² | | | | | | |

FIGS. 10-15 illustrate charge and discharge curves from the third cycle of coin cell C1a, C1b, C2a, C2b, C3, and C4, respectively.

For cells C1a and C1b (FIGS. 10 and 11, respectively), despite the current density being low and c-rate for the cathode being 0.06 hr⁻¹, the capacity under constant current charging conditions is only about 20 mAh/g versus a theoretical value of approximately 156 mAh/g. Charge-discharge plots show the hallmarks of high impedance and slow transport. There is an extended plateau for constant voltage charging, and there is a rapid drop in potential on discharge.

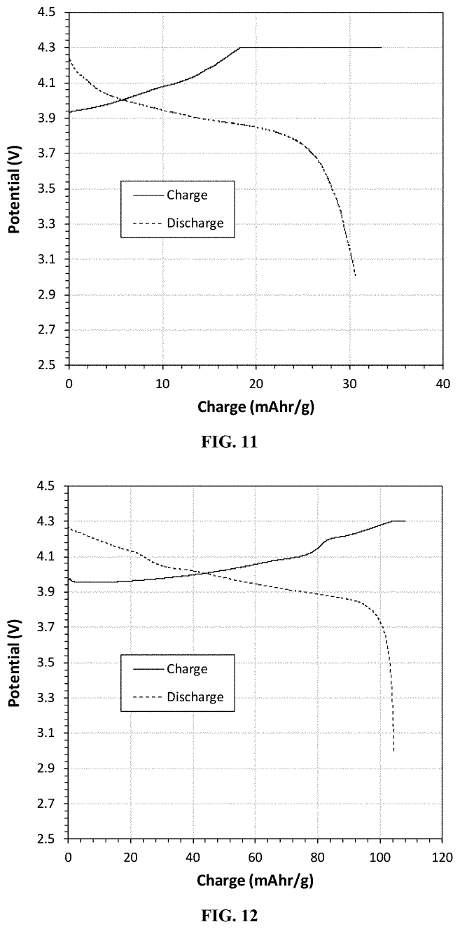

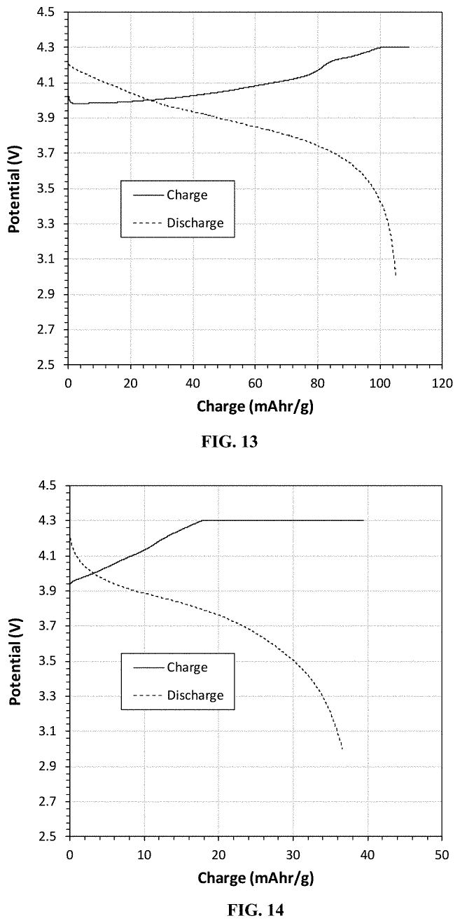

For cells C2a and C2b (FIGS. 12 and 13, respectively), a short, 1 hr heat treatment at 800° C. in air with abundant oxygen dramatically increases the capacity of otherwise identical cathodes. The capacity under constant current conditions rises to about 102 mAh/g, and about 65% of the theoretical value. The short heat treatment increases the electronic conductivity, comparing R1a and R1b to R2a and R2b, such that the cathode is no longer the rate-limiting process, which becomes lithium ion conduction in the cathode.

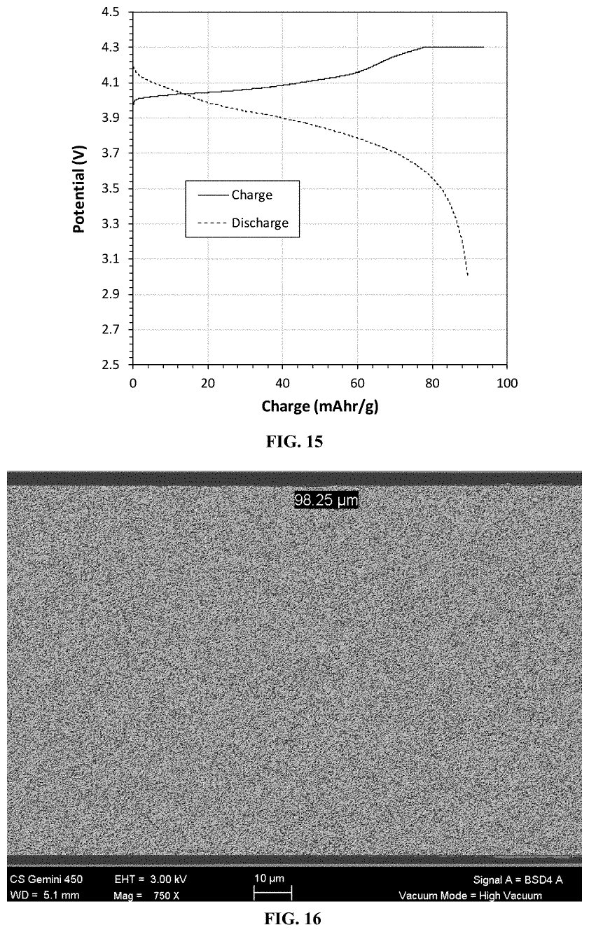

For cells C3 and C4 (FIGS. 14 and 15, respectively), the cells were loaded with cathodes treated for only 10 minutes at 800° C. in 0.02 vol. % 02 and 69 vol. % O₂, respectively, with argon serving as the make-up gas. These cells demonstrate the importance of oxygen rather than merely exposure to the elevated temperature for re-oxidation and recovery of high electronic conductivity. Although the cathode in cell C3 was exposed to 800° C., its charging capacity remains low, just 18 mAh/g. The charge-discharge traces for C3 are plotted in FIG. 14, and look similar to traces for cells C1a and C1b, shown in FIGS. 10 and 11, respectively. The constant current charging capacity of cell C4 in FIG. 15 with the cathode heat-treated in 69 vol. % O₂ is 78 mAh/g, and improvement of more than four-fold relative to C3. The somewhat lower capacity of C4 relative to C2a and C2b is likely due to the increase in cathode thickness, thereby lengthening distances for lithium ion conduction.

These examples illustrate the impact of a quenched-in, reduced state on electronic conductivity and rate capability of rapidly sintered LCO cathodes with closed pores. It is understood that re-oxidation to recover electronic conductivity that is greater than ionic conductivity applies to rapidly sintered cathodes with open pores and rapidly sintered cathodes based on other compositions like nickel-based chemistries that share the layered rock-salt structure with LCO. The examples provided here are not meant to be limiting. It is further understood that temperatures and times required for recovery of electronic conductivity are dependent upon composition, microstructure and design. A cathode of LCO with open pores would be expected to recover more quickly as distances for diffusion are shorter. Recovery of high electronic conductivity would take longer for a thicker LCO cathode with closed pores than a thin one. Nickel-based cathode compositions are well-recognized to be more sensitive to thermal reduction. Hence, they are expected to benefit even more from a post-sintering heat treatment step than LCO.

### Example 5—Rapidly Sintered Cathodes with Open Porosity

Rapidly sintered cathodes with 10-35% open porosity may be used to make thicker composite cathodes. In one embodiment, the composite structure is created by backfilling pores of the cathode with an ion-conducting electrolyte; for a lithium ion battery, the electrolyte may be a lithium ion conductor such as a liquid electrolyte (e.g., 1M solution of LiPF₆ dissolved in equal parts of ethylene carbonate (EC) and dimethyl carbonate (DMC) solvent). Alternatively, the pores can be filled with low-melting (<700° C.) solid ion conductors like lithium phosphosulphides (LPSs) or halides such as Li₃YCl₆, Li₃YBr₆ or Li₃AlCl₆ to make a solid-state, composite cathode. The open-pored, composite cathode structures have numerous advantages when compared to a closed-pore, non-composite cathodes. This may include a superior rate performance, a high internal surface area lowers effective charge transfer resistances, and distances for diffusion of ions like lithium into and out of the active material are shorter. A thicker cathode may therefore be used as the foundation for the single cell and few layers are required to build capacity.

FIG. 16 illustrates a polished cross-sectional scanning electron microscopy (SEM) image of a porous LCO cathode made through rapid sintering of an LCO tape of the same formulation used in the closed-pore formulations of, for example, Example 1. Rapid sintering was performed at a lower temperature of about 930° C. so that pores are retained. The pull speed used was 2.5 in/min. The final cathode contains approximately 30% of open porosity and has a thickness of ˜100 μm.

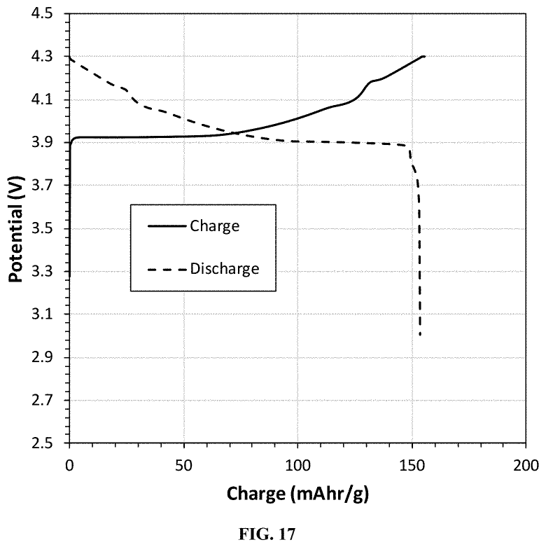

FIG. 17 illustrates charge and discharge curves from a coin cell comprising a porous LCO cathode. Electronic conductivity is yet more important to a thick electrode as distances for transport are longer. The electronic conductivity of the cathode of the present Example in the as-fired state is about 5×10⁻⁴ S/cm. The electronic conductivity increases to 8×10⁻⁴ S/cm after a heat treatment at 800° C. for 10 min in a mixture of 20 vol. % oxygen and 80 vol. % argon. Charge-discharge traces from a coin cell this cathode conducted at 0.1 C (0.4858 mA/cm²) rate are in FIG. 17. Resistance of the cell as judged by the change in potential upon start of discharge is <7 Ωcm². Capacity of the cathode is 154 mAh/g on both charge and discharge, near the theoretical value of 156 mAh/g.

Thus, the present disclosure relates generally to an electrode for a battery and to a method of preparing same. Novel, cathode-supported battery architectures are disclosed and may be designed for either existing lithium battery making processes or as a foundation for thin solid electrolytes (e.g., <10 μm) to enable lithium metal anodes. The sintered cathodes described herein enable higher energy density by more efficiently utilizing available space by: (1) eliminating the need for (a) a binder to hold individual cathode particles together, and (b) carbon conductors to move electrical current to and from the particles; and (2) serving as a mechanical support, without the need for supports.

The present application discloses rapidly sintered cathodes with layered rock-salt structures (and methods of forming thereof) for use in cathode-supported batteries having electronic conductivities faster than lithium transport. Current solutions for cathodes in lithium ion batteries is to include carbon conductors to facilitate electron transport. The cathodes disclosed herein do not need a secondary conducting phase, and in fact, addition of secondary conductive phases to closed-pore sintered cathodes are not practical for manufacturing purposes.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

As used herein, the term “porosity” is described as a percent by volume (e.g., at least 10% by volume, or at least 30% by volume), where the “porosity” refers to the portions of the volume of the sintered article unoccupied by the inorganic material.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise. References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method for forming a treated sintered composition, comprising:
providing a slurry precursor including a lithium-, sodium-, or magnesium-based compound;
tape casting the slurry precursor to form a green tape;
sintering the green tape at a temperature in a range of 500° C. to 1350° C. for a time less than 60 minutes to form a sintered composition; and then
heat treating the sintered composition at a temperature in a range of 700° C. to 1100° C. for a time in a range of 1 minute to 2 hours in an oxygen-containing atmosphere to form the treated sintered composition.

2. The method of claim 1, wherein the heat treating is conducted at a temperature in a range of 750° C. to 900° C. for a time in a range of 10 minutes to 1 hour.

3. The method of claim 1, wherein the oxygen-containing atmosphere comprises >0% to 70 vol. % O₂.

4. The method of claim 1, wherein the oxygen-containing atmosphere is air.

5. The method of claim 1, wherein the oxygen-containing atmosphere comprises at least one non-reactive gas.

6. The method of claim 1, wherein the oxygen-containing atmosphere does not include another reactive gas.

7. The method of claim 1, wherein the heat treating is conducted by:
inserting the sintered composition into a furnace at a first rate;
holding the sintered composition for a predetermined time;
withdrawing the sintered composition from the furnace at a second rate.

8. The method of claim 7, wherein the first rate is approximately equal to the second rate.

9. The method of claim 7, wherein the predetermined time is in a range of 1 minute to 30 minutes.

10. The method of claim 1, wherein the lithium-based compound comprises at least one of lithium cobaltite (LCO), lithium manganite spinel (LMO), lithium nickel cobalt aluminate (NCA), lithium nickel manganese cobalt oxide (NMC), lithium iron phosphate (LFP), lithium cobalt phosphate (LCP), lithium titanate, lithium niobium tungstate, lithium titanium sulfide, or combinations thereof.

11. The method of claim 1, wherein the lithium-, sodium-, or magnesium-based compound is at least 50 wt. % of the total slurry precursor.

12. The method of claim 1, wherein the magnesium-based compound comprises: at least one of NaVPO₄F, NaMnO₂, Na_{2/3}Mn_{1-y}Mg_{y}O₂ (0<y<1), Na₂Li₂Ti₅O₁₂, Na₂Ti₃O₇, MgCr₂O₄, or MgMn₂O₄.

13. The method of claim 1, wherein the slurry precursor further comprises at least one, solvent, dispersant, and plasticizer.

14. The method of claim 13, wherein the tape casting comprises:
forming the slurry precursor to a sheet configuration having a thickness in a range of 5 μm to 100 μm; and
drying the sheet configuration such that a combination of the at least one solvent, dispersant, or plasticizer does not exceed 10 wt. % of the dried sheet.

15. The method of claim 14, further comprising:
debinding the dried sheet at a predetermined temperature.

16. The method of claim 15, wherein the predetermined temperature is from 175° C. to 350° C.

17. The method of claim 15, wherein the step of debinding and the step of sintering are conducted simultaneously.

18. The method of claim 14, further comprising:
pyrolyzing organics in the dried sheet at a temperature from 175° C. to 350° C.

19. The method of claim 1, wherein the sintering is conducted for a time less than 45 minutes and comprises continually feeding the green tape through a sintering chamber at a predetermined rate.

20. The method of claim 1, wherein:
a final thickness of the sintered composition is in a range of 2 μm to 100 μm immediately after the sintering without further processing.

21. A treated sintered composition, comprising:
at least one of lithium cobaltite (LCO), lithium manganite spinel (LMO), lithium nickel cobalt aluminate (NCA), lithium nickel manganese cobalt oxide (NMC), lithium iron phosphate (LFP), lithium cobalt phosphate (LCP), lithium titanate, lithium niobium tungstate, lithium titanium sulfide, or combinations thereof,
wherein the treated sintered composition has an electronic conductivity of at least 10⁻⁵ S/cm.

22. The treated sintered composition of claim 21, wherein the electronic conductivity is at least 10⁻⁴ S/cm.

23. The treated sintered composition of claim 21, wherein the treated sintered composition has a porosity of between 10% and 30%.

24. The treated sintered composition of claim 21, wherein the porosity is less than 10%.

25. The treated sintered composition of claim 24, wherein the porosity is less than 3%.

26. The treated sintered composition of claim 21, wherein the treated sintered composition has at most trace quantities of a secondary conducting phase.

27. An energy device, comprising:
a first sintered, non-polished electrode having a first surface and a second surface;
a first current collector disposed on the first surface of the first electrode;
an electrolyte layer disposed on the second surface of the first electrode;
a second electrode disposed on the electrolyte layer; and
a second current collector is disposed on the second electrode.

28. The energy device of claim 27, wherein the first electrode comprises the treated sintered composition of claim 21.

29. The energy device of claim 27, wherein the electrolyte layer has a conductivity of at least 10⁻⁶ S/cm.

30. The energy device of claim 27, wherein the first electrode is a substrate of the energy device.
